(19) United States
(12) Patent Application Publication
(10) Pub. No.: US 2011/0203024 A1
(43) Pub. Date: Aug. 25, 2011

(54) Rifle Rated Ballistic Helmet

(76) Inventor: Arthur C. Morgan, Alexandria, VA (US)

(21) Appl. No.: 12/712,264

(22) Filed: Feb. 25, 2010

(51) Int. Cl. F41H 1/04; F41H 1/02; B32B 37/12; B32B 37/14; B32B 38/00

(52) U.S. Cl. 2/2.5; 2/6.6; 156/242

(57) ABSTRACT

This invention relates to armored protective helmets offering the wearer ballistic protection, and specifically to helmets offering lightweight ballistic protection from rifle ball ammunition. Potential applications include use by law enforcement personnel and combat soldiers.

### CROSS REFERENCE TO RELATED APPLICATIONS

Not applicable.

### STATEMENT REGARDING FEDERALLY SPONSORED RESEARCH OR DEVELOPMENT

No federal government funds were used in researching or developing this invention.

### NAMES OF PARTIES TO A JOINT RESEARCH AGREEMENT

Not applicable.

### REFERENCE TO A SEQUENCE LISTING

Not applicable.

### BACKGROUND

1. Field of the Invention

This invention relates to armored protective helmets offering the wearer ballistic protection, and specifically to helmets offering lightweight ballistic protection from rifle ball ammunition.

2. Background of the Invention

Body Armor

Body armor generally consists of protective clothing used to absorb the impact from firearm-fired projectiles and shrapnel fragments from explosions. The most basic component of armor usually consists of a vest for protection of the torso. The armor contained in such clothing can be either “soft”, meaning interwoven or laminated fibers, often made of “para-aramid” or ultra high molecular weight polyethylene (UHMWPE) fibers, or “hard”, meaning metal or ceramic plates. Body armor may contain soft or hard components, or both.

Ballistic Helmets

Ballistic helmets are well known in the prior art for use by persons to protect them against serious injury from shrapnel and other missiles. Most modern ballistic helmets are made from a plurality of plies of ballistic material which are laid up in a mold, cured with a resin and shaped to the configuration of the helmet.

One soft armor material which is well suited for use in making ballistic helmets is “para-aramid” fabric which includes aromatic polymide resins developed by E.I. duPont de Nemours and Company and sold under the trademarks “Kevlar” and Nomex”.

U.S. Pat. No. 5,190,802 discloses ballistic resistant laminates developed by bonding alternating plies of fabric woven from glass or normally solid organic polymers and non-woven scrim prepreg impregnated with a heat curable resin. A preferred organic polymer is an aramid exemplified by Kevlar. A preferred heat curable resin is phenol-formaldehyde/polyvinyl butyral blend. This patent discloses a method wherein the soft armor is shaped into a formed article during the curing of the fabric.

Another soft armor material which is well suited for use in making ballistic helmets is ultra high molecular weight polyethylene (UHMWPE).

U.S. Pat. Nos. 4,403,012 and 4,457,985 disclose ballistic-resistant composite articles comprised of networks of high molecular weight polyethylene or polypropylene fibers, and matrices composed of olefin polymers and copolymers, unsaturated polyester resins, epoxy resins, and other resins curable below the melting point of the fiber.

Ballistic helmets utilizing soft armor only and appearing in the prior art are rated at NIJ Level III-A or below, meaning such helmets will protect the wearer only against bullet fragments or a direct hit from a handgun, but not a direct hit from a rifle bullet.

Examples of rifle bullets against which protection is desired include the NATO M80 ball, the AK 47, the AK 74, the Russian LPS, the European SS109, and the like.

For example, U.S. Patent Application, Publication Number 20060286883 discloses a ballistic panel and associated methods of forming and using the same are provided, wherein the ballistic panel has a first plurality of fabric layers of woven fiber material and at least one layer of a plurality of substantially solid objects positioned to overlie the first plurality of fabric layers.

In another example, U.S. PCT application PCT/US2008/086021 discloses a helmet shell formed having an a inner section of fibrous layers, a middle section of fibrous layers and an outer section of fibrous layers containing high tenacity abrasive fibers in a resin matrix that resists penetration of rifle bullets. Upon being struck by a projectile, this outer layer would permanently deform and require replacement of the entire helmet.

Standard weight of a U.S. Army ACH-Style ballistic helmet, without hard external armor, is approximately 3.0 pounds for Medium, 3.25 pounds for Large and 3.75 pounds for Extra Large.

Increasing the weight of a helmet also increases the discomfort experienced by the wearer in the head, neck and shoulders. Increased discomfort can adversely effect the protection offered by the helmet, as it may cause the wearer to periodically position the helmet improperly or remove it altogether to gain relief from the weight.

Current helmets available to combat soldiers comprising only one or more layers of molded ballistic soft armor fiber are insufficient to protect against direct hits by rifle-fired projectiles. Mounted gunners and other soldiers routinely exposed to direct sniper fire and fragmentation threats require additional head protection.

What is needed is a lightweight ballistic helmet that is resistant to rifle round penetration.

What is needed is a helmet which is reusable with minor maintenance after a projectile hit.

### BRIEF SUMMARY OF THE INVENTION

Accordingly, there is provided a novel type of ballistic helmet for use in law enforcement and combat contexts, wherein an existing MICH, ACH or similar ballistic helmet is overlaid with interlocking hard armor plates of similar geometric shape, such as hexagons. Such small plates are comprised of a lightweight and high tensile strength material known in the art, such as metal, multi-ply UHMWPE or similar fibrous hard armor, or boron carbide, silicon carbide, alumina or similar ceramic. A layer of overlaid hard armor plates of sufficient thickness will provide additional penetration-resistant capability to the helmet sufficient to withstand the direct impact of a rifle-fired round of ammunition, such penetration resistance sufficient to attain an NIJ Level III rating for ballistic protection, without increasing the weight of a helmet to a point that its usefulness to the wearer is impaired due to discomfort.

In one preferred embodiment, a lightweight helmet that is resistant to penetration by rifle bullets, said helmet comprising from the inside to the outside: a shell, said shell comprising a plurality of fibrous layers said fibrous layers comprising a high tenacity abrasive fibers molded in a resin matrix; a plurality of substantially solid plates positioned to overlie and attach to all or a portion of the shell, the plurality of substantially solid plates being positioned in a single layer.

In another preferred embodiment, there is provided a lightweight helmet resistant to penetration by rifle bullets wherein the fibrous material used in constructing the shell is a para-aramid or UHMWPE fiber.

In another preferred embodiment, there is provided a lightweight helmet resistant to penetration by rifle bullets wherein the resin matrix used molding the shell comprises a thermoplastic resin.

In another preferred embodiment, there is provided a lightweight helmet resistant to penetration by rifle bullets wherein the plurality of solid objects are comprised of metal, fibrous materials or ceramics.

In another preferred embodiment, there is provided a lightweight helmet resistant to penetration by rifle bullets wherein the plurality of solid objects are shaped as interlocking geometrical shapes.

In another preferred embodiment, there is provided a lightweight helmet resistant to penetration by rifle bullets, said helmet comprising from the inside to the outside: a shell, said shell comprising a plurality of fibrous layers said fibrous layers comprising either para-aramid or UHMWPE fibers molded in a thermoplastic resin matrix; a plurality of substantially solid metal, fibrous material or ceramic plates positioned to overlie and attach to all or a portion of the shell with an adhesive, which objects may be shaped as interlocking geometrical shapes, such plurality of solid objects being positioned in a single layer.

In another preferred embodiment, there is provided a lightweight helmet resistant to penetration by rifle bullets wherein the plurality of interlocking solid plates are comprised of boron carbide, silicon carbide, alumina or multi-ply UHMWPE hard armor.

In another preferred embodiment, there is provided a lightweight helmet resistant to penetration by rifle bullets wherein the plurality of interlocking solid plates are shaped as hexagons. In another preferred embodiment, there is provided a lightweight helmet resistant to penetration by rifle bullets wherein the plurality of interlocking solid plates are shaped as squares.

In another preferred embodiment, there is provided a lightweight helmet resistant to penetration by rifle bullets wherein the each interlocking solid plate is one of 2.0 inches, 1.5 inches, or 1.0 inches in diameter.

In another preferred embodiment, there is provided a lightweight helmet resistant to penetration by rifle bullets wherein each interlocking solid plate is 0.6 cm in thickness.

In another preferred embodiment, there is provided a lightweight helmet resistant to penetration by rifle bullets wherein the area measuring approximately approximately the top 20% of surface area of the helmet, constituting the crown of the helmet, is devoid of such overlaying solid plates.

In another preferred embodiment, there is provided a lightweight helmet resistant to penetration by rifle bullets wherein the weight of the helmet does not exceed 6.85 pounds.

In another preferred embodiment, there is provided a lightweight helmet resistant to penetration by rifle bullets wherein, subsequent to the plurality of solid plates' attachment to the shell, the layer of solid plates is overlaid with a smooth polymer coating to provide a uniform finish.

In another preferred embodiment, there is provided a lightweight helmet, not to exceed 6.85 pounds in weight, that is resistant to penetration by rifle bullets, said helmet comprising from the inside to the outside: a shell, said shell comprising a plurality of fibrous layers said fibrous layers comprising either para-aramid or UHMWPE fibers molded in a thermoplastic resin matrix; a plurality of substantially solid metal objects positioned to overlie and attach to the lower 80% of the surface area of the shell with an adhesive, which plates shall be comprised of boron carbide, silicon carbide, alumina or multi-ply UHMWPE hard armor, which plates also may be shaped as interlocking hexagons, each interlocking hexagon being one of 2.0 inches, 1.5 inches or 1.0 inches in diameter, each interlocking octagon being 0.6 cm in thickness, such plurality of solid plates being positioned in a single layer, which layer of solid objects is overlaid with a smooth polymer coating to provide a uniform finish.

In another preferred embodiment, there is provided a method for construction of a lightweight helmet resistant to penetration by rifle bullets wherein said method comprising the steps of:
supplying a pre-fabricated molded ballistic helmet comprised of one of the Modular Integrated Communications Helmet or Advanced Combat Helmet, or another style of ballistic helmet similar thereto;
supplying a plurality of interlocking solid plates, each such object being hexagonal in shape and one of 2.0 inches, 1.5 inches or 1.0 inches in diameter, such hexagonal solid objects overlying and attaching to the pre-fabricated helmet in a single layer; attaching the plurality of interlocking solid plates to outer surface of the pre-fabricated helmet using flame treatment of such outer surface, followed by application of an adhesive; and
overlying the single layer of interlocking solid plates with a smooth polymer coating to provide a uniform finish.

### BRIEF DESCRIPTION OF THE DRAWINGS

FIGS. 1A and 1B show the prior art ACH and LWH helmets.

FIG. 2 is a line drawing evidencing the overlay of interlocking geometrically compatible plates over an ACH helmet shell, with the exception of the crown.

FIG. 3 is a line drawing evidencing the overlay of interlocking geometrically compatible plates over an LWH helmet shell, with the exception of the crown.

FIG. 4 is a line drawing evidencing the overlay of interlocking geometrically compatible plates over an entire ACH helmet shell.

FIG. 5 is a line drawing evidencing the overlay of interlocking geometrically compatible plates over an entire LWH helmet shell.

FIG. 6 is a line drawing evidencing geometrically compatible helmet armor plates having an interlocking feature.

FIG. 7 is a line drawing evidencing a cut-away view of the layers of a helmet of the present invention.

### DETAILED DESCRIPTION OF THE INVENTION

### Definitions

The following definitions are provided as an aid to understanding the detailed description of the present invention.

“Boron carbide” (chemical formula B₄C) is an extremely hard ceramic material used in tank armor, bulletproof vests, and numerous industrial applications. With a hardness of 9.3 on the mohs scale, it is one of the hardest materials known, behind cubic boron nitride and diamond. Boron carbide has a reported density of 2.52 g/cm³. Boron carbide is now produced industrially by the carbo-thermal reduction of B₂O₃ (boron oxide) in an electric arc furnace.

The “Modular Integrated Communications Helmet” (MICH), also known as the “Advanced Combat Helmet” (ACH), was developed by the United States Army Soldier Systems Center to be the next generation of protective combat helmets for use by the United States Army.

The “Lightweight Helmet” is the U.S. Marine Corps replacement for the PASGT combat helmet. The Lightweight Helmet is approximately the same size as the PASGT helmet, and is heavier than the Advanced Combat Helmet.

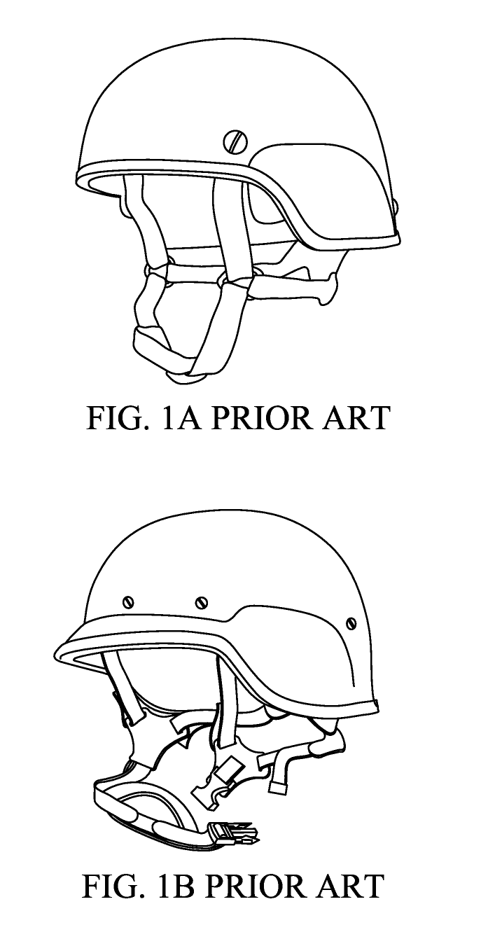

FIG. 1A shows an illustration of an ACH/MICH helmet, and FIG. 1B shows an illustration of a LWH helmet (prior art).

“NIJ Level IIIA” refers to the U.S. National Institute of Justice (NIJ) ballistic standard for armor with the following capabilities: “This armor protects against 8.1 g (125 gr) .357 SIG FMJ Flat Nose (FN) bullets at a velocity of 448 m/s±9.1 m/s (1470 ft/s±30 ft/s) and 15.6 g (240 gr) .44 Magnum Semi Jacketed Hollow Point (SJHP) bullets at a velocity of 436 m/s (1430 ft/s±30 ft/s). Conditioned armor protects against 8.1 g (125 gr) .357 SIG FMJ Flat Nose (FN) bullets at a velocity of 430 m/s±9.1 m/s (1410 ft/s±30 ft/s) and 15.6 g (240 gr) .44 Magnum Semi Jacketed Hollow Point (SJHP) bullets at a velocity of 408 m/s±9.1 m/s (1340 ft/s±30 ft/s). It also provides protection against most handgun threats, as well as the threats mentioned in NIJ Levels I, HA, and II. As used in this application, the term is also inclusive of the newer NIJ 0101.06 level of protection.

“NIJ Level III” refers to the NIJ ballistic standard for armor with the following capabilities: “This armor protects against 7.62 mm full metal jacketed (FMJ) bullets (U.S. military designation M80), with nominal masses of 9.6 g (148 gr), impacting at a minimum velocity of 838 m/s (2750 ft/s) or less. It also provides protection against Type I through III-A threats.”

While methods and systems of the present invention may be embodied in a variety of different forms, the specific embodiments shown in the figures and described herein are presented with the understanding that the present disclosure is to be considered exemplary of the principles of the invention, and is not intended to limit the invention to the illustrations and description provided herein.

There is provided a novel type of ballistic helmet for use by law enforcement personnel and combat soldiers, wherein an existing ballistic helmet, comprised of known ballistic fabric comprised of para-aramid, UHMWPE or similar fibrous “soft armor” further comprising a resin matrix, and molded in the MICH, ACH or similar helmet design, is used as the base shell.

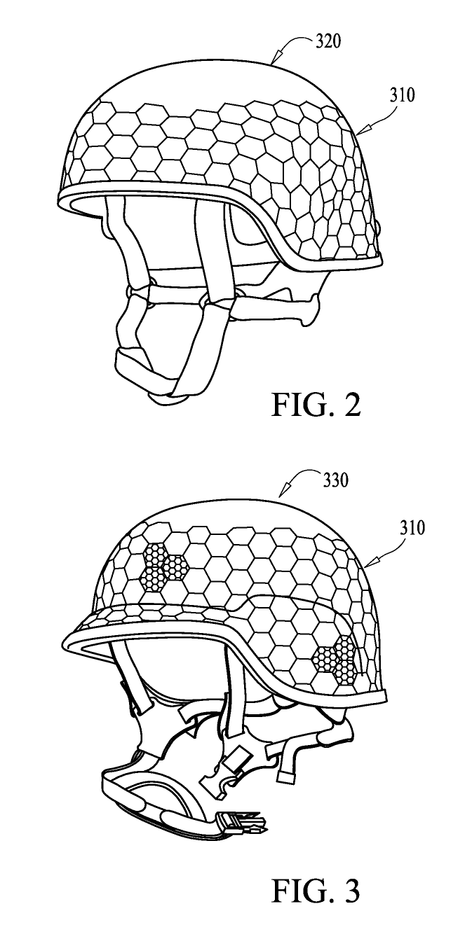

Referring now to the Figures, FIG. 2 is a drawing showing the hard armor plates 310 affixed to a standard ACH helmet 320, except for the crown. FIG. 3 is a drawing showing the hard armor plates 310 affixed to a standard Lightweight Helmet 330, except for the crown.

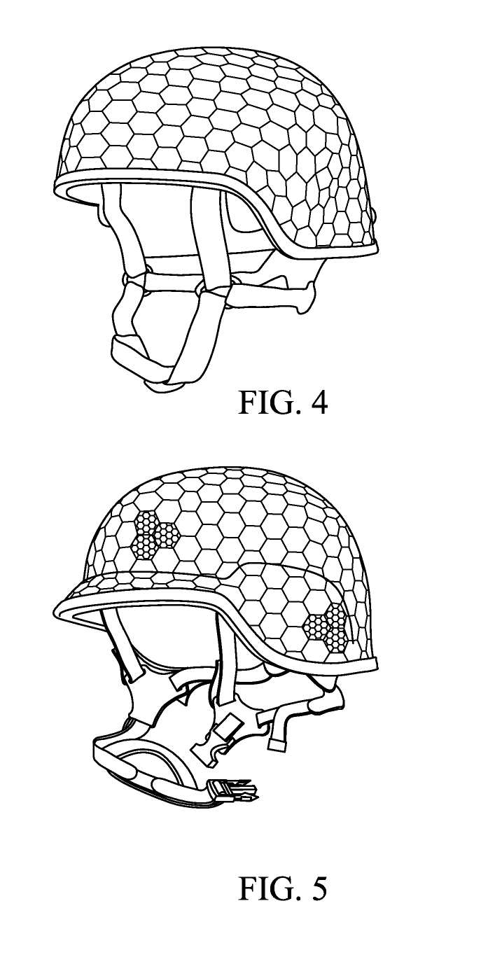

FIG. 4 is a drawing showing the hard armor plates affixed to an entire ACH helmet. FIG. 5 is a drawing showing the hard armor plates affixed to an entire Lightweight Helmet.

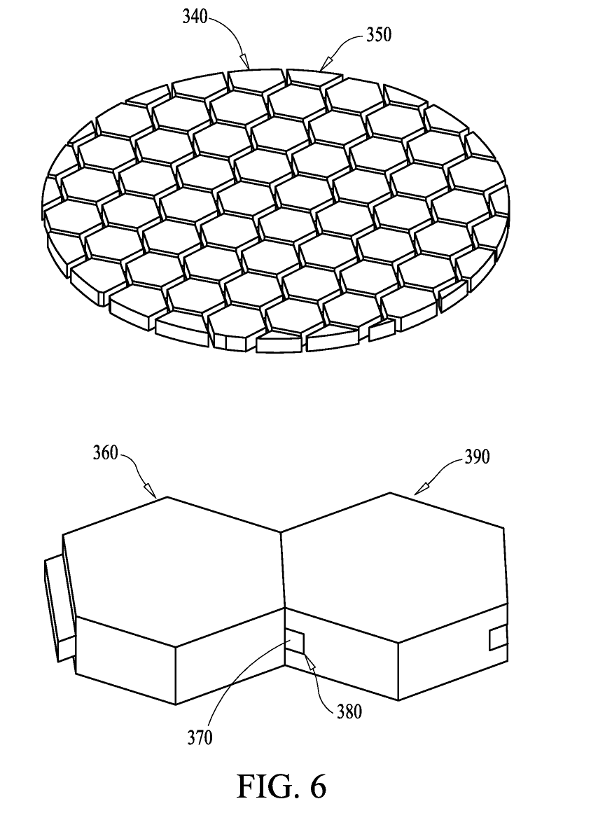

FIG. 6 shows how an interlocking feature is used in conjunction with the present inventive subject matter. FIG. 6 is a drawing demonstrating how geometrically similar plates may be located to create a seamless shell. Plate 340 abuts plate 350 without overlap. Plate 360 is attached by tongue 370 and groove 380 to plate 390.

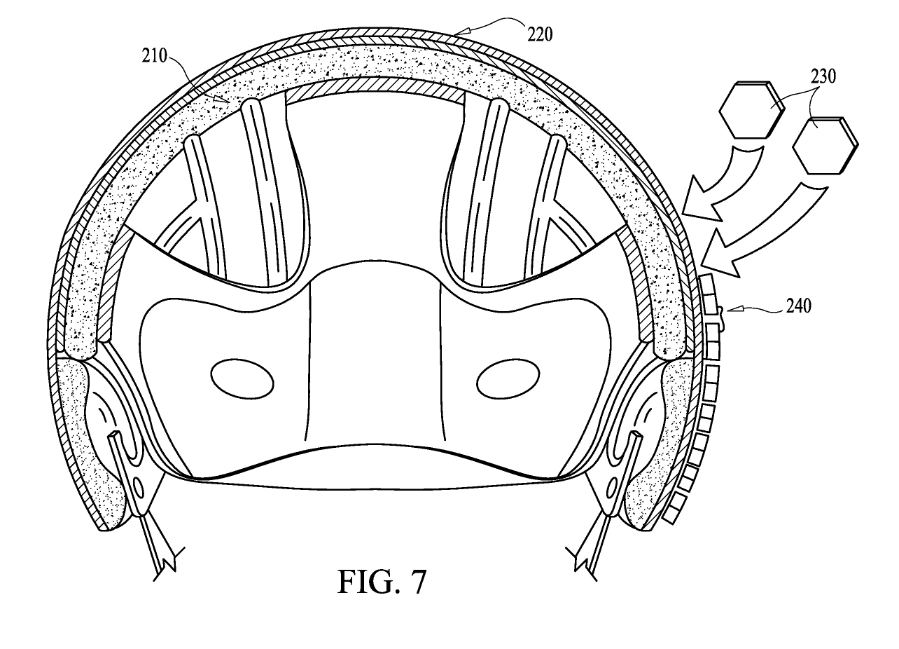

FIG. 7 is a cut-away view of a helmet of the present invention. FIG. 7 shows the layers from inside layer 210 to outer basement layer (foundation layer) 220 with hard armor plates 230 held by adhesive 240.

The plates can be 3 to 10 sided. In one preferred embodiment, the plates are six sided.

In another preferred embodiment, the plates are a combination of four-sided and eight-sided shapes. In another preferred embodiment, the plates are a combination of five-sided and six-sided shapes.

In another preferred embodiment, the plates are a combination of two or more of three-sided, four-sided, five-sided, six-sided and eight-sided shapes.

In one preferred non-limiting embodiment, the invention is comprised of the base shell helmet overlaid with a layer comprising a plurality of hexagonal-shaped, interlocking “hard armor” plates comprised of a known high-tensile strength material such as alumina, silicon carbide or boron carbide, the thickness of each such plate within a range from approximately 0.25 cm to 6.0 cm. The plates may be the same size or they may consist of a selection of varying sizes.

In another preferred embodiment, the plurality of interlocking hexagonal-shaped hard armor plates range from approximately 2 inches to 1 inch in diameter.

In another preferred embodiment, the plurality of interlocking shapes are comprised of a combination of octagonal and square shapes, wherein the length of a side of the interlocking octagon and square is equal.

In another preferred embodiment, the plurality of interlocking octagonal and square-shaped plates range from approximately 0.5 inches to 3 inches in diameter.

The thickness of each plate may be the same or may different depending on location. In a preferred embodiment, the plate's thickness ranges from about 0.1 cm to about 1.1 cm. In another preferred embodiment, the plate thickness ranges from about 0.2 cm to about 0.9 cm. In another preferred embodiment, the plate thickness ranges from about 0.3 cm to about 0.7 cm. In another preferred embodiment, the plate's thickness ranges from about 0.3 cm to about 0.5 cm. In another preferred embodiment, the plate's thickness is about 0.3 cm. In another preferred embodiment, the plate's thickness is about 0.6 cm.

In order to achieve a NIJ level III, it is contemplated that plates of 0.6 cm thickness are located at the front and sides. In one preferred embodiment, the helmet is about 100% covered with 0.6 cm thick plates. In another preferred embodiment, the crown of the helmet, which constitutes a low impact probability area, is uncovered by plates for purposes of weight reduction, resulting in approximately 80% of the helmet from the base of the shell to the crown being covered by plates.

In another preferred embodiment, there are about 50% 0.6 cm thick plates located in high impact probability areas, and about 50% 0.3 cm thick plates in remaining areas, percentages by surface area of the helmet. Percentages ranging from about 10% to about 90% of plates varying in thickness from about 0.3 cm to about 0.6 cm are also contemplated as within the present invention.

The plurality of variously-sized hard armor plates will be attached to the base shell helmet in an interlocking pattern to create a single layer of hard armor overlaying the shell. Attachment of the plates to the shell and to each other will be effected with a suitably durable polymer adhesive known in the art, and having the proper bonding properties to adhere to both the hard armor plates and soft armor shell.

When the basement outer layer is fabricated from UHMWPE, the preferred method of adhesion is flame treatment of the UHMWPE followed by application of a polyepoxide adhesive, since polyethylene is nonpolar and solvent-resistant, and flame treatment loosens the molecular bonds and makes them receptive to bonding with the adhesive.

Adhesives contemplated as within the scope of the present invention include: cyanoacrylate adhesives, toughened acrylic adhesives, epoxy adhesives in one part, two part and film form, polyurethane adhesives, silicone adhesives in single or two part forms, phenolic adhesives, polyimide adhesives, hot melt adhesives, plastisol adhesives, and rubber adhesives.

Although thermoset adhesives and flame curing are envisioned in one non-limiting embodiment, it is contemplated that chemical, UV light, and/or radiation cured adhesives may also be used.

Since one context in which the adhesive is used is attaching metal tiles to a polymeric helmet, the choice of adhesive may vary. In preferred embodiments, metal to non-metal bonding may be accomplished using epoxy resin adhesives, polyester-based adhesives, polysulfides, and neoprene/rubber-based adhesives.

When a full layer of interlocking hard armor plates has been attached, a final layer of polymer coating will be applied to the exterior surface of the hard armor layer, creating a smooth cosmetic finish.

In another preferred embodiment, a set of flush hard armor scales covered by a smooth polymer finish, comprising a seamless hard armor shell. Such seamless hard armor shell adhered with an appropriate polymer adhesive to an underlying resin-molded soft armor base shell, such base shell and seamless hard armor shell together comprising a lightweight ballistic helmet with a NIJ III-A level rating.

In a preferred embodiment, the full helmet weight ranges from approximately 4 to 7.5 pounds. In a more preferred embodiment, the weight range is approximately 5 to 6.85 pounds.

TABLE 1
USMC Lightweight Helmet Sizes

| | | Helmet Length | Helmet Width & |
|---|---|---|---|
| | LWH (lbs) | (mm) + pad | Height (mm) + pad |
| Size | (without BC armor) | spacing amount | spacing amount |
| Extra-Small | 3.0 | 180 + 30 | 142 + 30 |
| Small | 3.1 | 189 + 30 | 149 + 30 |
| Medium | 3.3 | 197 + 30 | 154 + 30 |
| Large | 3.5 | 206 + 30 | 159 + 30 |
| Extra-Large | 3.9 | 219 + 30 | 174 + 30 |

Since weight is related to surface area, the surface of a helmet can be approximated using Formula I. Formula I provides a calculation of a helmet shape, a prolate ellipsoid having length ‘a’, width ‘b’, and height ‘c’. Formula I has been modified by a factor of 60% due to the configuration of a helmet where the lower section of the ellipsoid is not present.

$$HELMET SURFACE AREA \\ \approx ( 4 {π ( \frac{{a}^{1.6075} {b}^{1.6075} + {a}^{1.6075} {c}^{1.6075} + {b}^{1.6075} {c}^{1.6075}}{3} )}^{0.6221} ) \times 0.60 \qquad FORMULA 1$$

Based upon the sizes provided for the Lightweight Helmet, the surface area of a helmet can be calculated. The surface area provides for calculation of the additional weight added by the armor. Table 2 below set forth non-limiting examples of the surface area to be covered, although these values will necessarily change depending on the design and size of the helmet.

TABLE 2
HELMET SURFACE AREA & WEIGHT

| | | Example of added weight (in grams) from |
|---|---|---|
| | Surface Area | 40% Boron Carbide overlay (density |
| Size | cm² | 2.52 g/cm³ at 0.6 cm thickness) |
| Extra-Small | 2,444 | 1,479 |
| Small | 2,650 | 1,603 |
| Medium | 2,822 | 1,707 |
| Large | 2,998 | 1,813 |
| Extra-Large | 3,432 | 2,075 |

Other hard armor materials and alloys contemplated within the scope of the present invention include silicon carbide, alumina or multi-ply UHMWPE hard armor.

In another preferred embodiment, a sleeve comprising two fabric outer layers with a plurality of contiguous hard armor plates sewn within such fabric layers.

It is also contemplated that such armored sleeve may be attached to the basement outer layer first and then this armored sleeve is attached to the helmet using velcro pads or a similar attachment mechanism. The wearer would thus be able to replace the hard armor sleeve in real time at the site of the conflict or engagement.

In the preferred embodiment, impact from a projectile, including and up to a direct hit from rifle ball ammunition, will deform the hard armor plate(s) and, perhaps the underlying soft armor shell as well, in the area struck by the projectile, resisting penetration by the projectile and spreading the force of the impact outward and away from the wearer's head.

The combined impact resistant properties of the hard armor plates and underlying soft armor shell will meet or exceed NIJ Level III rating requirements.

In another preferred embodiment, the hard armor plate(s) deformed or broken by a projectile impact will be removable and replaceable without the necessity of replacing the entire helmet.

It is also contemplated as within the scope of the invention, to provide the inventive helmet with additional components. Components include, without limitation, a ballistic face shield, a transparent face shield, a nape protector, a helmet cover, a ballistic neck protector, a transparent ballistic shield, pad and suspension kits, and one or more brackets or straps for additional equipment.

The references recited herein are incorporated herein in their entirety, particularly as they relate to teaching the level of ordinary skill in this art and for any disclosure necessary for the commoner understanding of the subject matter of the claimed invention. It will be clear to a person of ordinary skill in the art that the above embodiments may be altered or that insubstantial changes may be made without departing from the scope of the invention. Accordingly, the scope of the invention is determined by the scope of the following claims and their equitable Equivalents.

What is claimed:

1. A lightweight helmet that is resistant to penetration by rifle bullets, said helmet comprising from the inside to the outside: a shell, said shell comprising a plurality of fibrous layers said fibrous layers comprising a high tenacity abrasive fiber molded in a resin matrix; a plurality of substantially solid plates positioned to overlie and attach to all or a portion of the shell, the plurality of substantially solid plates being positioned in a single layer.

2. The helmet of claim 1 further comprising wherein the fibrous material used in constructing the shell is a para-aramid or UHMWPE fiber.

3. The helmet of claim 1 further comprising wherein the resin matrix used molding the shell comprises a thermoplastic resin.

4. The helmet of claim 1 further comprising wherein the plurality of solid objects are attached to the shell with an adhesive.

5. The helmet of claim 1 further comprising wherein the plurality of solid plates are comprised of metal, fibrous materials or ceramic.

6. The helmet of claim 1 further comprising wherein the plurality of solid objects are shaped as interlocking geometrical shapes.

7. A lightweight helmet that is resistant to penetration by rifle bullets, said helmet comprising from the inside to the outside: a shell, said shell comprising a plurality of fibrous layers said fibrous layers comprising either para-aramid or UHMWPE fibers molded in a thermoplastic resin matrix; a plurality of substantially solid metal, fibrous material or ceramic plates positioned to overlie and attach to all or a portion of the shell and to each other with an adhesive, which plates may be shaped as interlocking geometrical shapes, such plurality of solid plates being positioned in a single layer.

8. The helmet of claim 7 further comprising wherein the plurality of interlocking solid plates are comprised of boron carbide, silicon carbide, alumina or multi-ply UHMWPE hard armor.

9. The helmet of claim 7 further comprising wherein the plurality of interlocking solid plates are shaped as hexagons or squares.

10. The helmet of claim 7 further comprising wherein the each interlocking solid plate is one of 2.0 inches, 1.5 inches, or 1.0 inches in diameter.

11. The helmet of claim 7 further comprising wherein each interlocking solid plate is 0.6 cm in thickness.

12. The helmet of claim 7 further comprising wherein the area measuring approximately approximately the top 20% of surface area of the helmet, constituting the crown of the helmet, is devoid of such overlaying solid plates.

13. The helmet of claim 7 further comprising wherein the weight of the helmet does not exceed 6.85 pounds.

14. The helmet of claim 7 further comprising wherein, subsequent to the plurality of solid plates' attachment to the shell, the layer of solid objects is overlaid with a smooth polymer coating to provide a uniform finish.

15. A lightweight helmet, not to exceed 6.85 pounds in weight, that is resistant to penetration by rifle bullets, said helmet comprising from the inside to the outside: a shell, said shell comprising a plurality of fibrous layers said fibrous layers comprising either para-aramid or UHMWPE fibers molded in a thermoplastic resin matrix; a plurality of substantially solid plates positioned to overlie and attach to the lower 80% of the surface area of the shell and to each other with an adhesive, which plates shall be comprised of boron carbide, silicon carbide, alumina or multi-ply UHMWPE hard armor, which objects also may be shaped as interlocking hexagons or squares, each interlocking hexagon or square being one of 2.0 inches, 1.5 inches or 1.0 inches in diameter, each interlocking hexagon or square being 0.6 cm in thickness, such plurality of solid plates being positioned in a single layer, which layer of solid plates is overlaid with a smooth polymer coating to provide a uniform finish.

16. A method for constructing a lightweight helmet that is resistant to penetration by rifle bullets, said method comprising the steps of:
supplying a pre-fabricated molded ballistic helmet comprised of one of the Modular Integrated Communications Helmet, Advanced Combat Helmet or Lightweight Helmet, or another style of ballistic helmet similar thereto;
supplying a plurality of interlocking solid plates, each such plate being hexagonal or square in shape and one of 2.0 inches, 1.5 inches or 1.0 inches in diameter, such hexagonal or square solid objects overlying and attaching to the pre-fabricated helmet in a single layer;
attaching the plurality of interlocking solid plates to all or a portion of the outer surface of the pre-fabricated helmet using flame treatment of such outer surface, followed by application of an adhesive; and
overlying the single layer of interlocking solid objects with a smooth polymer coating to provide a uniform finish.
